(19) United States
(12) Patent Application Publication
(10) Pub. No.: US 2017/0010467 A1
(43) Pub. Date: Jan. 12, 2017

(54) HMPD WITH NEAR EYE PROJECTION

(71) Applicant: CastAR, Inc., Palo Alto, CA (US)

(72) Inventor: Jeri ELLSWORTH, San Jose, CA (US)

(21) Appl. No.: 15/205,736

(22) Filed: Jul. 8, 2016

Related U.S. Application Data
(60) Provisional application No. 62/190,207, filed on Jul. 8, 2015.

(51) Int. Cl. G02B 27/01; G02B 5/12

(52) U.S. Cl. CPC G02B 27/0172; G02B 5/12; G02B 2027/0178; G02B 2027/0132; G02B 2027/015

(57) ABSTRACT

A head mounted projection display includes an optical path to support near eye projection of the projected images. That is, the projection aperture is placed close to the user's eye. In one implementation, image projectors are located in an image projector compartment located above left and right observation lenses. The projected images are directed down and behind respective observation lenses. Additional optics then redirect the projected images out of the observation lenses. This arrangement provides various advantages. One advantage is that it that allows for reduced forward protrusion of the projector compartment.

### CROSS REFERENCE TO RELATED APPLICATIONS

The present application claims the benefit and priority to provisional application 62/190,207, the contents of which are hereby incorporated by reference.

### U.S. PATENT DOCUMENTS INCORPORATED BY REFERENCE

The following U.S. Patent Publications and Patent Applications are hereby incorporated by reference, US2014/0340424, Ellsworth and U.S. Ser. No. 14/272,054, Ellsworth.

### FIELD OF THE INVENTION

An embodiment of the current invention is directed to a head mounted projection display (HMPD) in which images are projected from points near the eyes of a user.

### DESCRIPTION OF THE RELATED ART

The HMPD is a special form of the well known head mounted display in which projectors are mounted to a frame or headset worn by a user. Images from the projectors are then reflected from a special screen back into the user's eyes. Conventional HMPD design employs beam splitters in front of the user's eyes to allow the viewing of returning light in a coaxial relation to the projected light. The beam splitters pose a disadvantage, however, in that their position and angle in front of the user's eyes require a headset that protrudes farther forward than conventional glasses. To reduce this bulk and simplify manufacturing, the projectors may be mounted, without beam splitters, close to the user's eyes as taught in Ellsworth, U.S. Patent Publication 2014/0340424. However, projectors with projection lens systems co-linear relative to the spatial light modulator require a distance to the lenses that, again, adds protrusion.

### SUMMARY

Embodiments of the present invention are directed to head mounted projection displays (HMPDs) having near eye projection. In one embodiment, the HMPD has a glasses frame, first and second observation lenses, and an image projector compartment. Optics support initially directing the projected images down behind the observation lenses and then redirecting the projected image out through the observation lenses. In one embodiment, the image projector compartment includes light sources and spatial optical modulators.

One embodiment of the HMPD of the current invention comprises an arrangement of optical components that reduces a protrusion of the projector compartment compared with directly projecting images from the projector compartment. In one embodiment, images from projection system located on the headset frame are reoriented so as to project downward into the space just behind the top rim over the observation lenses, where a mirror, right angle prism, or other optical components are positioned to redirect the projection light forward through said observation lenses. In one embodiment, the HMPD uses any filtering that is available in said observation lenses when placed in the outgoing projection light path.

The HMPD may also be utilized to achieve other benefits via near eye projection. In one embodiment the near eye projection supports receiving a brighter returned image. In one embodiment, the near eye projection allows for projection rays to originate closer to the eyes of the user compared with HMPDs in which the projection rays originated from the image projector compartment. This is turn, may result in some applications in brighter returned image. For example, having the projection rays originated closer to the eyes of the user may result in the return a brighter image when reflected by a commercially available retroreflective sheeting, wherein the sheeting has a low observation angle that returns light very close to the projection origin.

It will also he understood that embodiments of the present invention include methods of operating the HMPD. In one embodiment this includes the HMPD receiving images to be projected and projecting the images via near eye projection.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative implementations, is better understood when read in conjunction with the appended drawings. For the purpose of illustrating the implementations, there is shown in the drawings example constructions of the implementations; however, the implementations are not limited to the specific methods and instrumentalities disclosed. In the drawings:

FIG. 1 illustrates a prior art head mounted projection display device.

FIG. 2 illustrates a head mounted projection display device in accordance with an embodiment of the current invention.

FIG. 3 illustrates the prior art projector optical path of FIG. 1.

FIG. 4 illustrates a top view of the projector optical path of an embodiment of the current invention.

FIG. 5 illustrates a front view of the projector optical path of an embodiment of the current invention.

### DETAILED DESCRIPTION

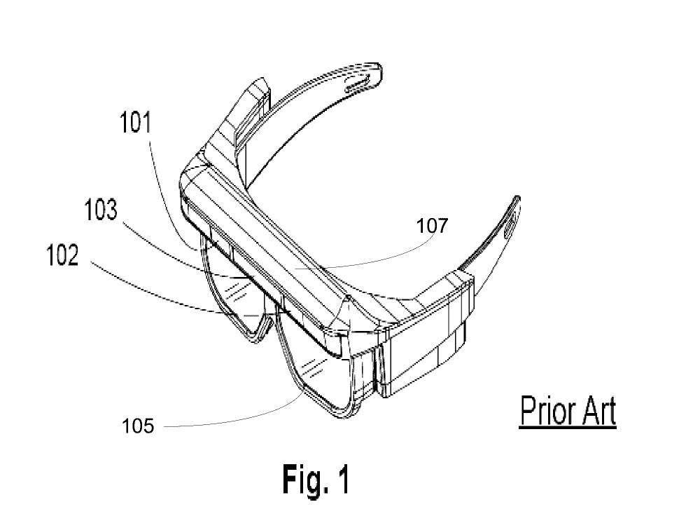

FIG. 1 shows a HMPD unit of the prior art. There are two observation lenses 105. A projector compartment 107 is located above the viewing lenses 105 in a brow region. The projector compartment 107 protrudes out relative to the viewing lenses 105. This projector compartment 107 has image projectors located behind brow windows 101 and 102, and tracking cameras located behind window 103. Although the image projectors have been designed to have a small vertical thickness, the brow of the projection compartment 107 of the headset must be extended forward to accommodate the optical length necessary for the projection lenses.

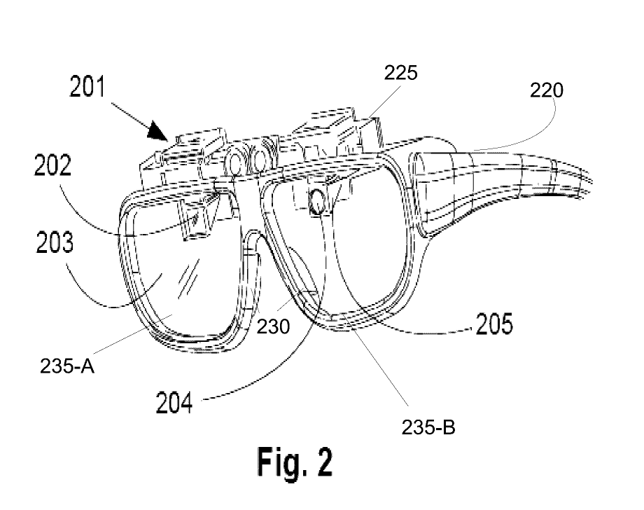

The configuration of an embodiment of the current invention is shown in FIG. 2. Some conventional HMPD components are omitted for the purposes of clarity. For example, the HMPD of FIG. 2 may include a compact power source (e.g., a battery or a power connector), a microprocessor controller, and a communications interface to receive graphical images to be projected that are generated by a computing system (not shown in FIG. 2). If the HMPD of FIG. 2 includes a tracking module to track a user's head and/or eye movement, the HMPD may include an interface to transmit tracking information to the computing system.

A glasses frame 220 is provided. An image projector compartment 225 is disposed above a lens portion 230 that includes a first observation lens 235-A and a second observation lens 235-B. Here the top of the projector compartment has been removed, for illustration purposes, to show the internal parts 201. The right observation lens 203 is shown while the corresponding lens on the other side has been removed for the purposes of illustration. Likewise, the final projection lens 202 is shown while the corresponding lens of the other side has also been removed revealing the projection exit aperture 204 on the right angle mirror assembly 205. As can be seen in FIG. 2, the projection exit aperture 204 may be located in an upper region of an observation lens. In this example, the projection exit aperture 204 is not coaxial with a center eye position but is near the eye of a user. The projection of images through each observation lens is thus near eye projection. It is noted that in some applications, having the projection rays originate closer to the eyes of the user may result in the return of a brighter image returned to the user's eye.

In one embodiment, a complete system would include a retroreflective screen to return projected images back to the eyes of the user. Thus images projected out from the left observation lens would be retroreflected back to the user and images projected out from the right observation lens would be retroreflected back to the user. In one embodiment, the HMPD may include filtering techniques known in the art to prevent cross-talk of images by isolating the returning left and right projected images to their respective eyes. This may include, for example, polarizing filters, although it will be understood that other types of filters could be used.

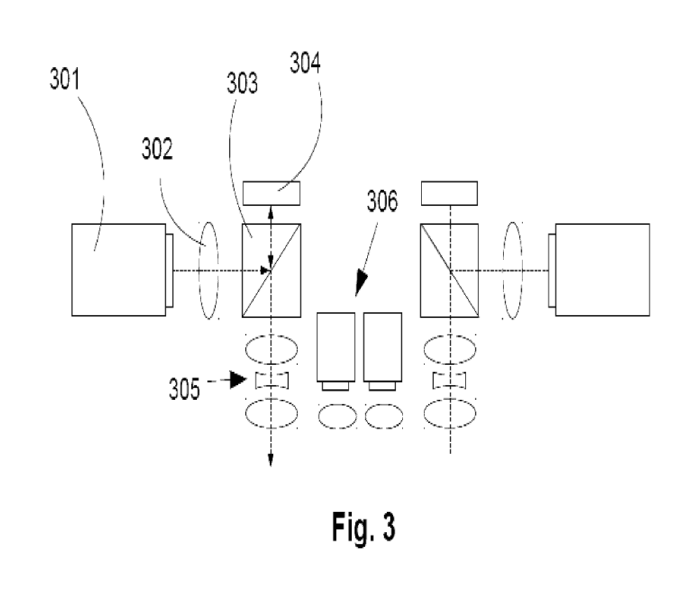

The optical path diagram for the prior art device of FIG. 1 is shown in top view in FIG. 3. Light originates in an illumination source (typically LED based) 301 and is then collected and focused by lens means 302 and directed by beam splitter/combiner cube 303 to be spatially modulated by a spatial modulator 304, such as Liquid Crystal on Silicon (LCOS) reflective matrix panel. The image formed and reflected by spatial modulator 304 then travels through 303 to be projected out (101 in FIG. 1) by the lens system 305. The left and right projection sections are separated by a pair of infrared tracking cameras 306.

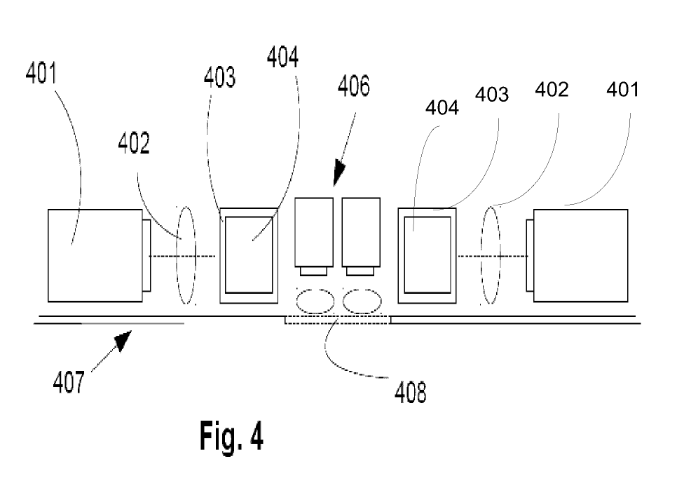

In an embodiment of the current invention, the optical path can be made to cause less forward protrusion of the projector compartment 225 by rotating the horizontal axis of the projector configuration ninety degrees such that the path of generated images out of the projector compartment 225 initially goes down (vertically) instead of forward directly out through the front of projector compartment 225. That is, the images that are generated for each eye are initially directed vertically down behind the observation lenses and then are directed out perpendicularly through the observation lenses 235-A, 235-B. This rotation is shown in FIG. 4 which is, again, a view from the top looking down. Each individual left/right image projector includes the components to generate a sequence of optical images in response to computer commands (e.g., via an illumination source and spatial light modulator), direct the light of the optical images down behind an observation lens, and then redirect the light through a portion of an observation lens.

Each respective spatial light modulator panel 404 is illuminated by a light source 401 to generate a set of optical images. Each respective spatial light modulator panel 404 is now located above a respective splitter/combiner cube 403. Each splitter/combiner cube 403 directs the light from its associated spatial modulator panel 404 down. The windows 101 and 102 have been eliminated in the front brow plate 407, which still has a window 408 for the infrared tracking cameras 406.

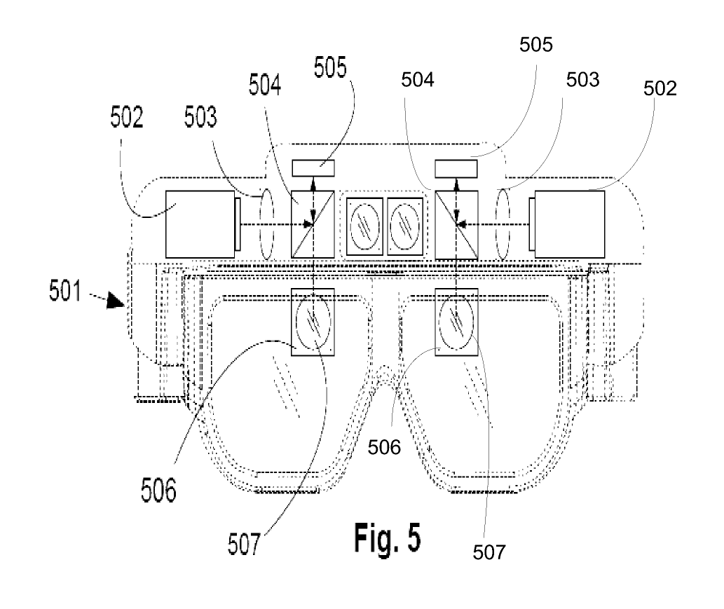

FIG. 5 shows how the arrangement of the image generators and associated optics direct the light from each image projector separately down vertically and then perpendicularly out through separate observation lenses would be positioned with respect to a glasses housing 501. As in FIG. 4 the optical path (for an individual image projector) begins with an illuminator 502 that is focused at 503 and is then directed by splitter/combiner 504 to be modulated at spatial modulator panel 505. However, in FIG. 5 it can be seen that the optical path drops through the housing to be directed forward by a mirror or prism of an optical component 506 and then projected by lens or lens system 507 (corresponding to 202 in FIG. 2).

Those skilled in the art will understand that the invention could be practiced with the projection lens or lens system 507 located above optical component 506 such that 506 turns the final projection rays. Also, those skilled in the art will understand that curvature may be introduced in the surface of optical component 506 so as to provide part or all of the function of the projection lens or lens system.

In the prior art such as Ellsworth US Patent Publication 2014/0340424, polarizing filters have been applied to the projection means so as to reduce light entering the opposite eye when matched to filters in or on the observation lenses. A goal of the current invention is achieved by eliminating the need for filters at the projectors through the mounting of projector apertures behind the observation lenses, such that the filters at or in those lenses filter the image light going both forward and reflected. Ellsworth US 2014/0340424 teaches several means of filtering for the purpose of isolating the left and right images to their respective eyes, and those skilled in the art will understand that said means may also be used with the current invention.

Those skilled in the art will understand that, as also disclosed in Ellsworth US 2014/0340424, the observation lenses and filtering may be eliminated by close placement said projector apertures to their respective eyes and the use of retroreflective sheeting with sufficiently low observation angle as to segregate the reflected images to their respective eyes.

While examples have been provided of components to generate images, it will be understood that the invention is not limited to a particular image generation techniques.

An illustrative embodiment has been described by way of example herein. Those skilled in the art will understand, however, that change and modifications may be made to this embodiment without departing from the true scope and spirit of the elements, products, and methods to which the embodiment is directed, which is defined by my claims.

That which is claimed:

1. A head mounted projection display with near eye projection, comprising:
a glasses frame having a lens portion with a first observation lens and a second observation lens, wherein each observation lens has an inner surface and an outer surface;
an image projector compartment located in a brow region disposed above the lens portion;
first optics to direct images generated in the image projector compartment downward behind the observation lenses of said glasses; and
second optics to redirect said the generated images and project them forward through said observation lenses.

2. The head mounted display of claim 1, wherein said second optics is disposed behind said observations lenses.

3. The head mounted display of claim 2, wherein said second optics comprises one or more right angle mirrors or prisms located behind said observation lenses, said mirrors or prisms redirecting said generated images forward through said observation lenses.

4. The head mounted display of claim 1, wherein said second optics comprises one or more right angle mirrors or prisms located behind said observation lenses, said mirrors or prisms redirecting said generated images forward through said observation lenses.

5. The head mounted projection display of claim 1, wherein the image projector compartment includes a first spatial light modulator and a second spatial light modulator.

6. The head mounted projection display of claim 1, further comprising at least one filter to isolate reflected left and right images to respective left and right observation lenses.

7. The head mounded projection display of claim 6, wherein said at least one filter reduces cross-talk of left and right projected images returned to said head mounted projected display by filtering, at each observation lens, reflected light originally projected via the opposite observation lens.

8. The head mounted projection display of claim 1, where said second optics comprises a curved surface.

9. The head mounted projection display of claim 1, further comprising a retroreflective screen to return projected images.

10. The head mounted projection display of claim 1, wherein the head mounted projection display is configured to reduce a brow protrusion of the image projector compartment.

11. A head mounted projection display with near eye projection, comprising:
a glasses frame having a lens portion with a first observation lens and a second observation lens, wherein each observation lens has an inner surface and an outer surface;
an image projector compartment located in a brow region disposed above the lens portion, the image projector compartment including a first image generator and a second image generator to generate a first and second sequence of images in response to computer commands, respectively;
first projection optics to direct said first sequence of generated images generated by said first image generator behind the first lens and redirect said first generated images forward through said first observation lens; and
second projection optics to direct said second sequence of generated images generated by said second image projector behind the second lens and redirect said projected images forward through said second observation lens.

12. The head mounted display of claim 11, wherein:
said first projection optics include one or more right angle mirrors or prisms located behind first observation lenses to redirect said first generated images forward through said first observation lens; and
said second projection optics include one or more right angle mirrors or prisms located behind second observation lenses to redirect said second generated images forward through said second observation lens.

13. The head mounted projection display of claim 11, wherein the image projector compartment includes a first spatial light modulator and a second spatial light modulator.

14. The head mounted projection display of claim 11, further comprising at least one filter to reduce cross-talk of left and right projected image by filtering, at each observation lens, reflected light originally projected via the opposite observation lens.

15. A head mounted projection display with near eye projection comprising:
a glasses frame having a lens portion with a first observation lens and a second observation lens, wherein each observation lens has an inner surface and an outer surface;
an image projector compartment located in a brow region disposed above the lens portion;
first image projection means to generate first images from a first image projector in said image projector compartment, direct said first images downward behind the first observation lens, and redirect said first projected images forward through said first observation lens; and
second image projection means to generate second images from a second image projector in said image projector compartment, direct said second images downward behind the second observation lens, and redirect said second images forward through said second observation lens.

16. A method of operating a head mounted projection display, comprising:
generating a first set of images to be projected in a projector compartment of the head mounted display, directing the first set of images behind a first observation lens and redirecting the first set of images forward through the first observation lens; and
generating a second set of images to be projected in a projector compartment of the head mounted display, directing the second set of images behind a second observation lens and redirecting the second set of images forward through second first observation lens.

17. The method of claim 16, further comprising filtering reflected images received by the head mounted projection display to isolate received left and right eye projected images.
